(19) United States
(12) Patent Application Publication
(10) Pub. No.: US 2002/0079151 A1
(43) Pub. Date: Jun. 27, 2002

(54) Three-part front-face structure for a motor vehicle, the structure including a cooling module

(75) Inventors: Laurent Decker, Villeurbanne (FR); Hugues Cheron, Bourg Saint Christophe (FR)

Correspondence Address: OLIFF & BERRIDGE, PLC, P.O. BOX 19928, ALEXANDRIA, VA, 22320, US

(73) Assignee: COMPAGNIE PLASTIC OMNIUM, Lyon (FR)

(21) Appl. No.: 10/020,995

(22) Filed: Dec. 19, 2001

(30) Foreign Application Priority Data
Dec. 19, 2000 (FR) 00 16600

(51) Int. Cl. B60K 11/04

(52) U.S. Cl. 180/68.4; 180/68.6

(57) ABSTRACT

The invention provides a front-face structure for a motor vehicle, the structure being based on a cooling module (6) having a rigid frame. The front-face structure comprises two end pieces (7) that serve to support at least one functional member of the vehicle, these two end pieces being shaped in such a manner as to extend the cooling module (6) over the entire front face of the vehicle, each occupying a corner of the vehicle.

The present invention relates to a three-part front-face structure for a motor vehicle, said structure including a cooling module.

Front-face structures, which are to be found at the front of vehicle engine compartments, support all or part of the cooling system of the engine, which system is constituted by a radiator, a motor-driven fan unit, and optionally a condenser, and a shroud for the fan unit.

In the description below, the components of the cooling system are referred to overall by the term “cooling module”.

One of the difficulties with known front-face structures is that they give only limited access to the cooling module once mounted on the vehicle. Furthermore, in order to dismantle the cooling module, it is necessary to dismantle the entire front-face structure which leads to high labor costs.

More precisely, with known front-face structures, the difficulty in dismantling lies in the location of the connections between the cooling module and the engine block. When these connections are completely separate from the engine block, as is the case with one-piece front-face structures, mounting the front-face structure onto the vehicle in the factory is made easier, but extracting the cooling module on its own is not possible. Conversely, when the cooling module is supported by the engine block, it is easy to extract from the front-face structure, but it then becomes more expensive to mount on the vehicle in the factory.

Furthermore, each model of vehicle has its own model of front-face structure, whereas the components of the cooling module can be standardized.

Finally, another drawback of front-face structures is that their function of supporting numerous parts of the vehicle requires them to be very rigid which makes them more expensive and restricts design options, particularly for making them out of a plurality of parts, which would nevertheless help reduce costs, both during manufacture and during mounting.

The present invention proposes a novel front-face structure which gives easy access to the cooling module and makes it easy to dismantle, which enables front-face structures to be standardized, and which provides novel and economically advantageous options in the making of such a front-face structure.

The present invention provides a front-face structure for a motor vehicle, the structure being prefitted with a cooling module and being characterized in that it comprises, in combination:

a rigid frame of a cooling module; and

two end pieces serving as a support for at least one functional member of the vehicle, these two end pieces being connected to the rigid frame of the cooling module by rigid connections and being shaped in such a manner as to extend the cooling module across the entire front face of the vehicle, each occupying a corner of the vehicle, each end piece including means for fixing to the structure of the vehicle.

In general, the cooling module includes a carrier element serving as a rigid frame, which can be constituted by the radiator or by the shroud, and which is also referred to as a “cassette” when it includes a beam constituting the top cross-member of the front-face structure.

By providing rigid connections between the frame of the cooling module and the end pieces, the front-face structure of the invention solves the problem of vibration from the radiator being transmitted to the front-face structure. This vibration is due to flow turbulence and to water hammer, and even though water hammer has almost completely disappeared from modern cooling circuits, it is still considered by the person skilled in the art as being something that needs to be taken into account, if only out of force of habit.

In a particular embodiment, the front-face structure further comprises a cross-member interconnecting the end pieces, preferably a top cross-member, e.g. to provide a fastening point for a lock for closing the engine compartment.

In simplified manner, obtaining a front-face structure of the invention amounts to adding two end pieces on either side of the cooling module, optionally together with a cross-member interconnecting the two end pieces.

It will thus be understood that access to the cooling module and dismantling thereof are made much easier.

Furthermore, given that those parts of the front-face structure which are closely allied to the appearance of the vehicle are specifically the ends of the structure, which ends are situated in the corners of the vehicle, the invention is advantageous in that adapting the front-face structure to another model of vehicle can be done very easily, solely by replacing the end pieces. In other words, standardizing the front-face structure does not raise any difficulties insofar as the same technical elements can very easily be used on vehicles having technical characteristics that are identical but appearances that are different, for example vehicles of different marques or badges but sharing a common platform.

Another remarkable advantage of the invention is that the front-face structure derives its rigidity from the cooling module. Instead of presenting significant rigidity itself as a piece that is separate from the cooling module and that carries the cooling module as a component which subjects it to mechanical stress, the front-face structure of the invention takes advantage of the presence of the cooling module and integrates it as one of its own constituent elements, adding end pieces that provide additional rigidity only in those portions of the front face that are not occupied by the cooling module.

Furthermore, making up the front-face structure as three parts that are assembled together presents numerous advantages.

Firstly, making the two end parts by molding a plastics material is made easier and less expensive because the pieces in question are small. It is advantageous to mold two end pieces of small size instead of an entire front-face structure as a single piece.

No piece of the front-face structure of the invention extends across the entire width of the vehicle, so the geometrical size of the front-face structure can be adapted to the width required by any particular vehicle by acting on the fastenings between the rigid frame and the end pieces.

In addition, in accordance with the invention, it is possible to use a material that is particularly adapted to each portion of the front-face structure without encountering difficulties associated with overmolding or comolding a plurality of different materials. In particular, it is advantageous to use a structural material, generally a material that is quite expensive, a plastics material or a sheet metal or a hybrid material, for the cross-member so as to impart good mechanical properties thereto, in particular so as to enable it to withstand the hood being slammed shut, and to use a material that is less expensive, such as polypropylene, for the end pieces.

In a particular embodiment, the rigid frame of the cooling module is secured to the end pieces by means that serve to position it longitudinally and vertically relative to the vehicle.

In accordance with the invention, the top portion of the cooling module can be positioned in the X and the Z directions (i.e. horizontally along the longitudinal axis of the vehicle and vertically), and its bottom portion can be referenced in the X direction.

The top portion of the cooling module could also be referenced in the X direction and its bottom portion can be referenced in the X and the Z directions.

X direction and Y direction positioning can be performed on the end pieces only.

Nevertheless, another option is to provide for positioning the top portion on a top cross-member whose ends are fixed to the end pieces.

Similarly, if the front-face structure includes a low beam, which beam can form part of the cooling module, bottom portion positioning can be performed on the low beam.

The present invention provides, in particular, a front-face structure as described above and in which the rigid frame of the cooling module is a shroud.

The invention also provides a set of two end pieces for fitting to the rigid frame of a cooling module so as to make up a front-face structure as described above.

To make the invention easier to understand, various embodiments are described below with reference to the accompanying drawings, in which:

FIG. 1 is an exploded perspective view of a cooling module whose carrier element is a radiator;

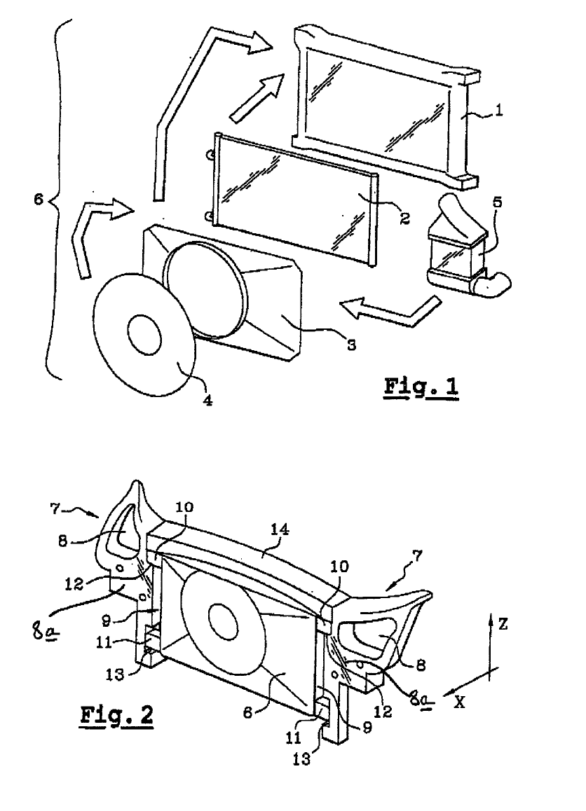

FIG. 2 is a perspective view of a front-face structure constituting a first embodiment of the invention and including the cooling module of FIG. 1;

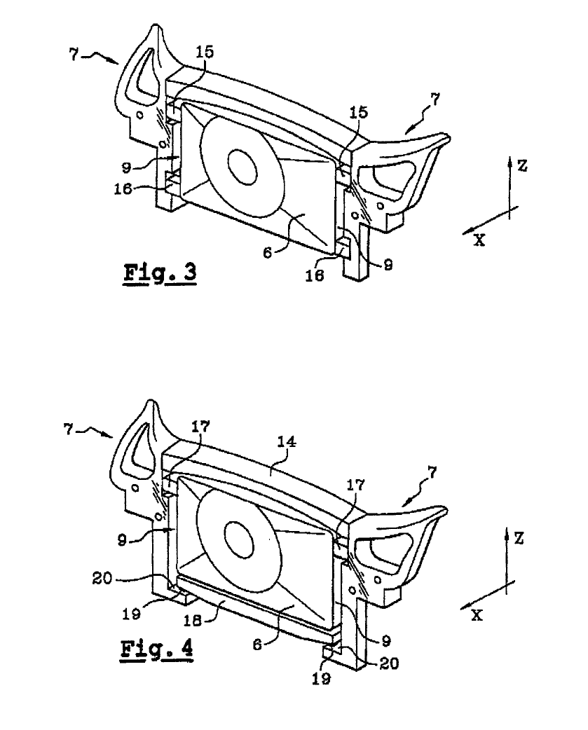

FIG. 3 is a view analogous to FIG. 2 showing a front-face structure constituting another embodiment of the invention;

FIG. 4 is a view analogous to FIG. 2 showing a front-face structure constituting another embodiment of the invention;

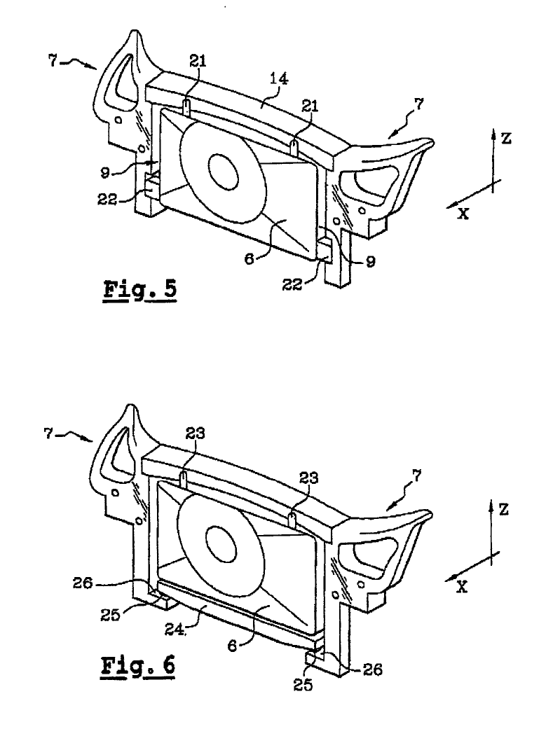

FIG. 5 is a view analogous to FIG. 2 showing a front-face structure constituting another embodiment of the invention;

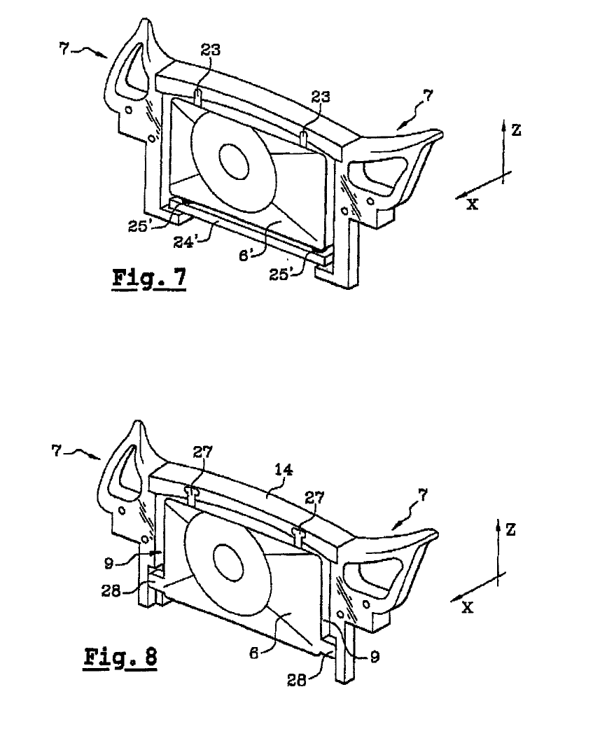

FIG. 6 is a view analogous to FIG. 2 showing a front-face structure constituting another embodiment of the invention;

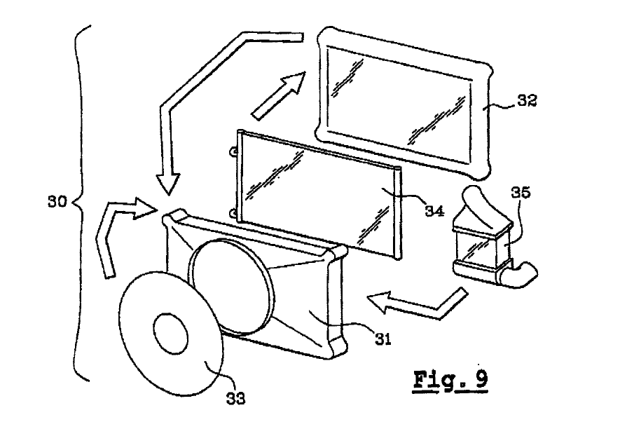

FIG. 7 shows a variant of the FIG. 6 embodiment;

FIG. 8 is a view analogous to FIG. 2 showing a front-face structure constituting another embodiment of the invention;

FIG. 9 is an exploded perspective view of a cooling module whose carrier element is a shroud;

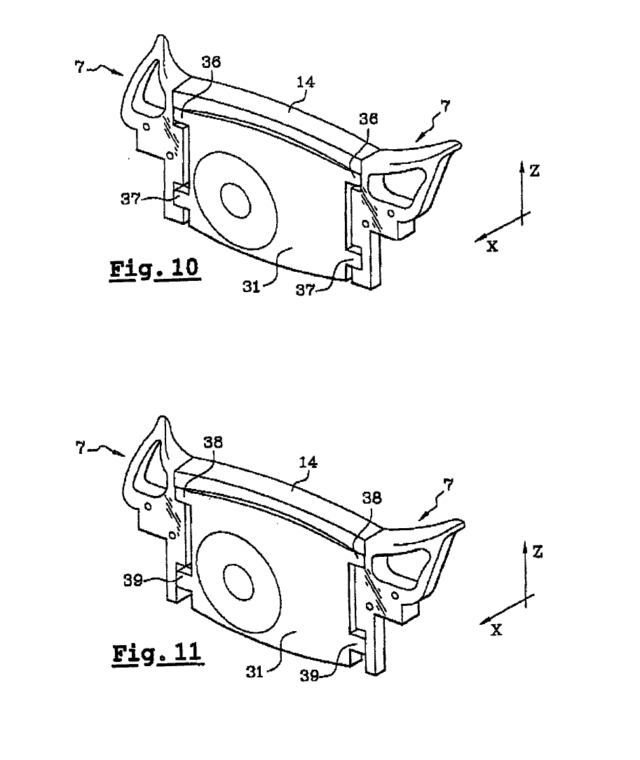

FIG. 10 is a perspective view of another front-face structure constituting another embodiment of the invention, and including the FIG. 9 cooling module;

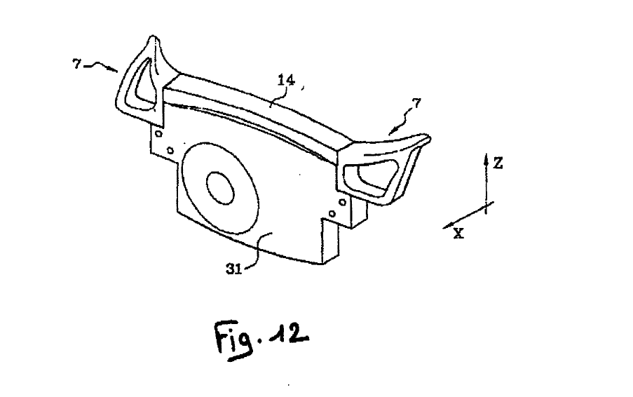

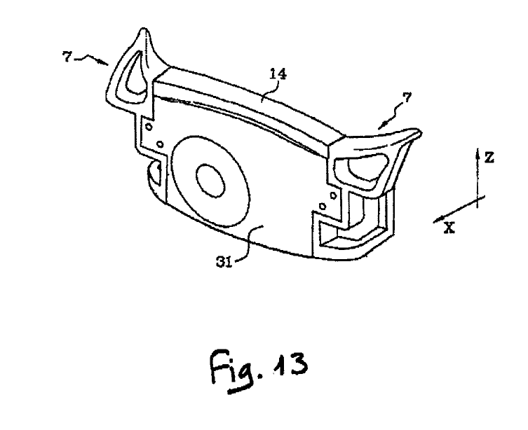

FIG. 11 is a view analogous to FIG. 10 showing a front-face structure constituting another embodiment of the invention; and

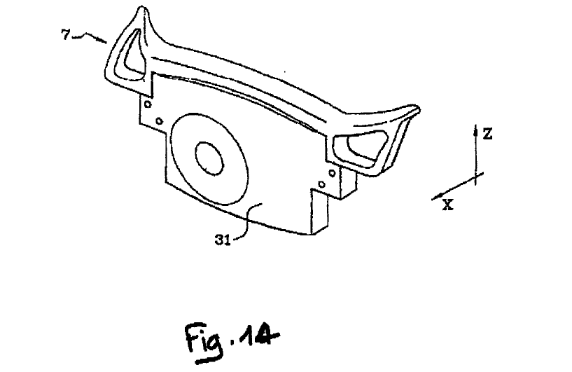

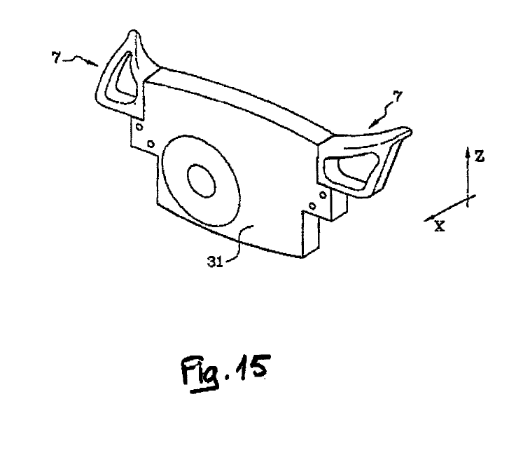

FIGS. 12, 13, 14, and 15 are views analogous to the preceding figures showing other variant embodiments of the front-face structure of the invention.

In FIG. 1 there can be seen the components of a cooling module: a radiator 1, a condenser 2, a shroud 3, and a motor-driven fan unit 4. Accessories such as a supercharging auxiliary radiator (intercooler) 5 can be added to the assembled module.

The arrows in FIG. 1 show the order in which the parts are connected to one another.

Thus, the fan unit 4 is mounted on the shroud 3 which is mounted on the radiator 1. The condenser 2 is also mounted on the radiator 1. The accessories 5 are mounted on the resulting assembly.

The resulting cooling module assembly 6 can be used to form a front-face structure as shown in FIG. 2 which is constituted by the module 6 and by two end pieces 7.

Each end piece 7 is located on a respective side of the module 6 and it occupies a corner of the vehicle. It has a housing 8 for a headlamp unit and various supports for other functional members of the vehicle.

Beneath the housing 8, a fixing plate 8a serves to mount the end piece, and thus the entire front-face structure on the end of a side rail (not shown).

The module has four rigid studs projecting from its two small side faces 9 in the vicinity of its top and bottom edges.

The two top studs 10 serve to position the module relative to the end pieces 7 in the X and Z directions. The two bottom studs 11 provide X direction positioning.

To this end, each end piece has a top receptacle 12 and a bottom receptacle 13 in the form of notches that open out towards the module.

Each stud can be fixed in the corresponding receptacle by any means that ensure a rigid connection.

A high cross-member 14 is fixed via its two ends to the two end pieces 7. It can be seen that the front-face structure uses the cooling module as a central structural element mounted on the structure of the vehicle via the end pieces.

Depending on the dimensions of the cooling module, the width of the end pieces is adapted so as to cover the entire front of the vehicle.

In FIG. 3, the cooling module 6 likewise has four rigid studs projecting from its small side faces 9.

In this embodiment, the two top studs 15 are used for positioning in the X direction, while the two bottom studs 16 are used for positioning in the X and the Z directions.

A high cross-member 14 interconnects the two end pieces.

In the embodiment of FIG. 4, the cooling module 6 has only two rigid studs 17, located near the top. Near the bottom, the cooling module 6 has a low beam 18 whose two chamfered ends carry studs 19.

These bottom studs 19 rest in receptacles 20 forming portions of the end pieces and serving to position the cooling module relative to the end pieces in the X and Z directions. The top studs 17 provide for positioning in the X direction relative to the end pieces. A high cross-member 14 reinforces the rigidity of the assembly.

In the embodiment of FIG. 5, the cooling module 6 has two top studs 21 projecting from its top edge and two bottom studs 22 projecting from its two small side faces 9.

The two top studs 21 provide positioning in the X direction relative to the high cross-member 14. The two bottom studs 22 provide positioning in the X and the Z directions relative to the end pieces.

In the embodiment of FIG. 6, the cooling module 6 has two top studs 23 projecting from its top edge and providing positioning in the X direction relative to the high cross-member. At its bottom, the cooling module includes a low beam 24 whose chamfered ends present studs 25 which, by bearing against receptacles 26 integral with the end pieces 7, serve to provide positioning in the X and the Z directions.

FIG. 7 shows a variant of the FIG. 6 embodiment in which the low beam 24′ is secured via its ends to the end pieces 7.

The cooling module 6′ then has its bottom resting on the cross-member 24′ via studs 25′ which serve to provide positioning in the X direction.

In the embodiment of FIG. 8, two top studs 27 project from the top edge of the module 6 and provide it with positioning in the X and Z directions relative to a high cross-member 14, while two bottom studs 28 project from the small side faces 9 of the module 6 to provide positioning in the X direction relative to the end pieces 7.

FIG. 9 shows the component parts of a cooling module 30 whose carrier element is the shroud 31 and not the radiator 32. As in FIG. 1, the arrows represent the connections between the parts.

The motor-driven fan unit 33 is mounted on the shroud 31. The condenser 34 is mounted on the radiator 32 which is mounted on the shroud 31.

The accessories 35 are mounted on the resulting assembly.

In the embodiment of FIG. 10, the cooling module 31 resulting from assembling the part shown in FIG. 9 has rigid studs projecting from its small side faces in the vicinity of its top and bottom edges. The two top studs 36 provide positioning in the X direction relative to the end pieces 7 and the two bottom studs 37 provide positioning in the X and the Z directions.

In the embodiment of FIG. 11, positioning in the X and Y directions is provided by the two top studs 38 while the bottom studs 39 provide positioning in the X direction only.

In the embodiments of FIGS. 10 and 11, a high cross-member 14 interconnects the two end pieces.

In the variants of FIGS. 12 to 15, the cooling module is slightly different. Its rigid frame is constituted by a shroud 31 which includes the fixing plate for fixing to the side rails of the vehicle.

The embodiments described above are provided merely as examples and should not be interpreted as constituting any kind of limitation on the scope of the invention, which is defined by the accompanying claims.

1. A front-face structure for a motor vehicle, the structure being prefitted with a cooling module and being characterized in that it comprises, in combination:
a rigid frame (1, 31) of a cooling module; and
two end pieces (7) serving as a support for at least one functional member of the vehicle, these two end pieces being connected to the rigid frame of the cooling module by rigid connections and being shaped in such a manner as to extend the cooling module (6, 31) across the entire front face of the vehicle, each occupying a corner of the vehicle, each end piece including means for fixing to the structure of the vehicle.

2. A front-face structure according to claim 1, characterized in that the rigid frame of the cooling module is a radiator or a shroud.

3. A front-face structure according to claim 1 or claim 2, characterized in that it includes a cross-member (14), preferably a high cross-member (14), interconnecting the end pieces (7).

4. A front-face structure according to any one of claims 1 to 3, characterized in that the rigid frame (1, 31) of the cooling module is secured to the end pieces (7) via means that provide for longitudinal and vertical positioning thereof relative to the vehicle.

5. A front-face structure according to any one of claims 1 to 4, characterized in that the top portion of the cooling module is positioned in the X and the Z directions (i.e. horizontally along the longitudinal axis of the vehicle and vertically) while the bottom portion is referenced in the X direction.

6. A front-face structure according to any one of claims 1 to 4, characterized in that the top portion of the cooling module is referenced in the X direction while the bottom portion thereof is referenced in the X and the Z directions.

7. A front-face structure according to any one of claims 1 to 6, characterized in that positioning in the X and Z directions is performed solely on the end pieces (7).

8. A front-face structure according to claim 3 and any one of claims 1 to 6, characterized in that the top portion is positioned via the high cross-member (14).

9. A front-face structure according to any one of claims 1 to 6 and 8, characterized in that the bottom portion is positioned relative to a low beam (18).

10. A front-face structure according to any one of claims 1 to 9, in which the rigid structure of the cooling module is a shroud.

11. A set of two end pieces for fitting to the rigid frame of a cooling module so as to constitute a front-face structure according to any one of claims 1 to 10.
